(19) United States
(12) Patent Application Publication
(10) Pub. No.: US 2024/0296492 A1
(43) Pub. Date: Sep. 5, 2024

(54) PERSONALIZED POINT-OF-SALE GRAPHICAL USER INTERFACE

(71) Applicant: International Business Machines Corporation, Armonk, NY (US)

(72) Inventors: Fang Lu, Billerica, MA (US); Jeremy R. Fox, Georgetown, TX (US); Randy A. Rendahl, Raleigh, NC (US); Uri Kartoun, Cambridge, MA (US)

(21) Appl. No.: 18/176,508

(22) Filed: Mar. 1, 2023

(51) Int. Cl. G06Q 30/0601; G06N 3/091; G06Q 20/20

(52) U.S. Cl. CPC G06Q 30/0641; G06N 3/091; G06Q 20/208

(57) ABSTRACT

According to one embodiment, a method, computer system, and computer program product for a personalized, point-of-sale graphical user interface is provided. The embodiment may include detecting an object for purchase that requires additional user input on a point-of-sale (POS) device. The embodiment may also include generating a custom user interface display on the POS device based, at least in part, on the detected object and historical purchase information associated with a user purchasing the detected object.

### BACKGROUND

The present invention relates generally to the field of computing, and more particularly to point-of-sale systems.

Point-of-sale relates to relates to the time and place at which a transaction, typically a retail transaction, is completed. At the point-of-sale, an amount owed by a purchasing party to a selling party is calculated and payment is tendered and exchanged from the purchasing party to the selling party thus completing the transaction. Traditionally, point-of-sale systems, or devices utilized to assist in executing transactions at the point-of-sale, were operated by representatives of the selling party, such as cashiers for a retail establishment. Many point-of-sale systems were highly specialized computing devices that needed adequate training to properly operate. However, due to more customer-friendly innovations, many point-of-sale systems now allow a purchasing party to operate the point-of-sale system (e.g., a self-checkout) while a representative for the selling party may be nearby to offer assistance when needed.

### SUMMARY

According to one embodiment, a method, computer system, and computer program product for a personalized, point-of-sale graphical user interface is provided. The embodiment may include detecting an object for purchase that requires additional user input on a point-of-sale (POS) device. The embodiment may also include generating a custom user interface display on the POS device based, at least in part, on the detected object and historical purchase information associated with a user purchasing the detected object.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a personalized, point-of-sale training process according to at least one embodiment.

FIG. 3 illustrates an operational flowchart for a personalized, point-of-sale operation process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to point-of-sale systems. The following described exemplary embodiments provide a system, method, and program product to, among other things, personalize a point-of-sale system using recurrent user trends mined from historical, user-specific data. Therefore, the present embodiment has the capacity to improve the technical field of point-of-sale systems by improving a point-of-sale graphical user interface through personalization that increases efficiencies throughout user utilization of a point-of-sale device and aides in the identification of items detrimental to or avoided by the user. Furthermore, a reduction in consumed resources may be also be observed through a reduction in the time per point-of-sale transaction.

As previously described, point-of-sale relates to relates to the time and place at which a transaction, typically a retail transaction, is completed. At the point-of-sale, an amount owed by a purchasing party to a selling party is calculated and payment is tendered and exchanged from the purchasing party to the selling party thus completing the transaction. Traditionally, point-of-sale systems, or devices utilized to assist in executing transactions at the point-of-sale, were operated by representatives of the selling party, such as cashiers for a retail establishment. Many point-of-sale systems were highly specialized computing devices that needed adequate training to properly operate. However, due to more customer-friendly innovations, many point-of-sale systems now allow a purchasing party to operate the point-of-sale system (e.g., a self-checkout) while a representative for the selling party may be nearby to offer assistance when needed.

During the point-of-sale process at a user-operated point-of-sale device, a user often needs to report on items not associated with a barcode, such as produce. At times, these items can number in the dozens, which may require weighing or counting of each individual item thus lengthening the self-checkout process. Furthermore, user errors or frustrations with a lack of ease of use with a point-of-sale system may result in inventory shrinkage. Inventory shrinkage relates to any loss of an item by retails due to factors other than sales. For example, when users navigate a self-checkout system, several menus and/or inputs must be entered to properly input some items. When a user becomes frustrated that inputting a specific item is taking too long or results in multiple errors, the user may input the item as a different item in order to continue with the checkout process thus resulting in incorrect inventory numbers and potential revenue loss by the seller. As such, it may be advantageous to, among other things, rather than present a user with dozens of items for user entry, identify specific items a user typically purchases using historical user data and generating and presenting a graphical user interface depicting a list of the identified items to the user.

According to one embodiment, a personalized, point-of-sale program may capture various data items of user preferences and purchase history in order to generate a knowledge corpus of common user purchases and a frequency at which specific items are purchased. Once the personalized, point-of-sale program has satisfied a confidence threshold for various categories, the personalized, point-of-sale program may deploy the knowledge corpus for a specific user. Once deployed, the personalized, point-of-sale program may identify a user is operating a point-of-sale device, detect an item is presented by the user to the point-of-sale device, and generate a custom user interface display to the user based on the knowledge corpus.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

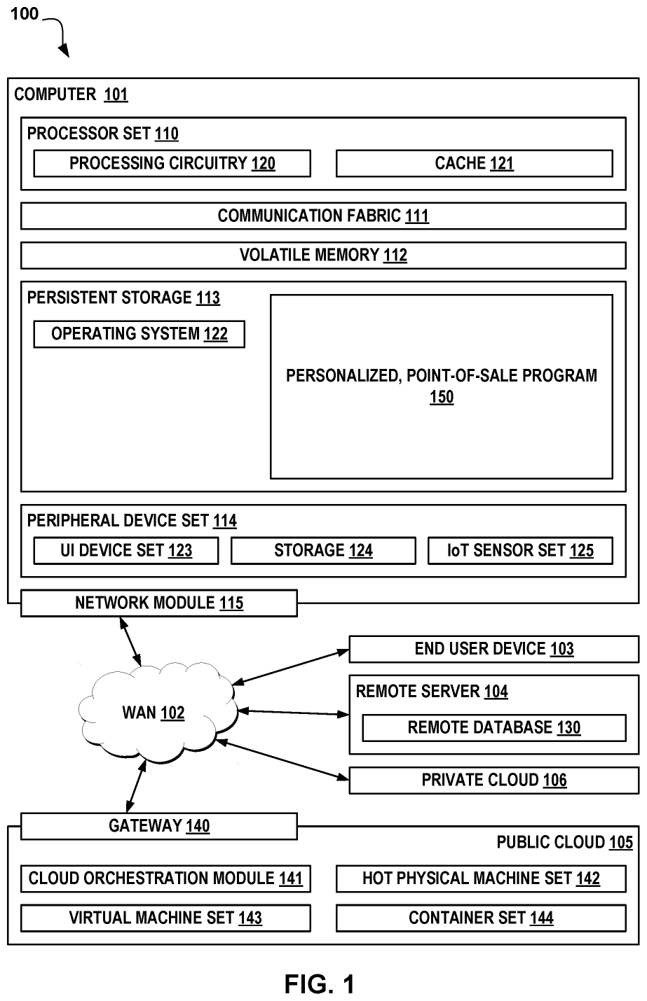

Referring now to FIG. 1, computing environment 100 contains an example of an environment for the execution of at least some of the computer code involved in performing the inventive methods, such as personalized, point-of-sale program 150. In addition to personalized, point-of-sale program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and personalized, point-of-sale program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in personalized, point-of-sale program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in personalized, point-of-sale program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

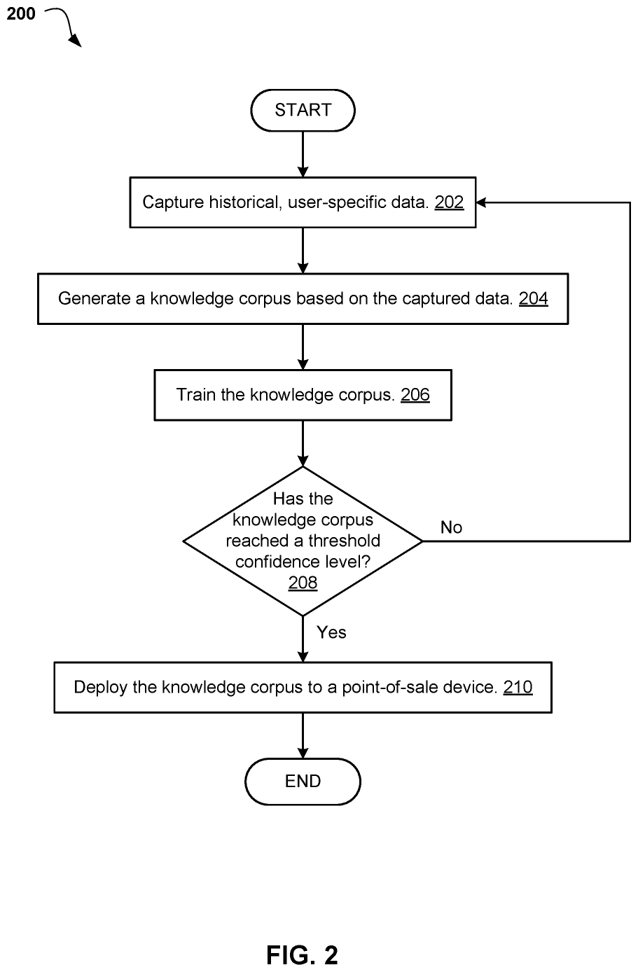

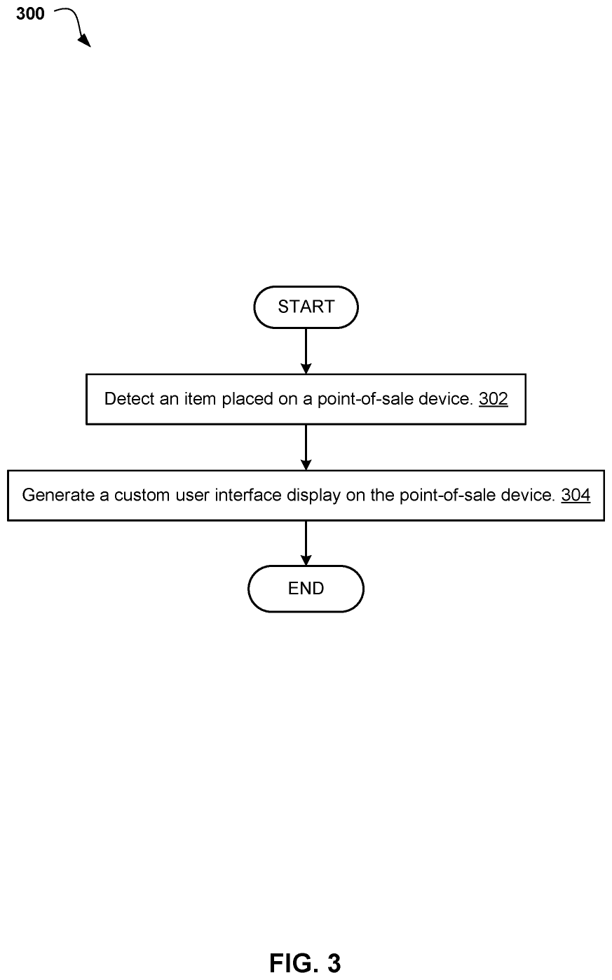

According to at least one embodiment, the personalized, point-of-sale program 150 may receive historical, user-specific data that may include prior user purchases and item uses. Using the historical, user-specific data, the personalized, point-of-sale program 150 may generate a knowledge corpus that show user habits and routines and may be used to make predictions of future user routines. Upon generating and deploying the knowledge corpus, the personalized, point-of-sale program 150, at a point-of-sale system, may detect an item presented to the point-of-sale system requiring manual user input. The personalized, point-of-sale program 150 may utilize the knowledge corpus to generate a graphical user interface customized depicting predicted items matching the presented item. Furthermore, notwithstanding depiction in computer 101, the personalized, point-of-sale program 150 may be stored in and/or executed by, individually or in any combination, end user device 103, remote server 104, public cloud 105, and private cloud 106. The personalized, point-of-sale method is explained in more detail below with respect to FIGS. 2 and 3.

Referring now to FIG. 2, an operational flowchart for a personalized, point-of-sale training process 200 is depicted, according to at least one embodiment. At 202, the personalized, point-of-sale program 150 captures historical, user-specific data. As a user conducts transactions, a seller may collect various transaction record details, such as electronic transaction records, voice recognition of the purchase, receipt scans, or loyalty card scans. The personalized, point-of-sale program 150 may capture information within a seller repository relating to a specific user, once the user opts-in as described below, in order to build a knowledge corpus of user-specific information. In another embodiment, the personalized, point-of-sale program 150 may capture seller information such as inventory information and optional user customizations to each item. For example, if the seller is a restaurant, the personalized, point-of-sale program 150 may capture a menu and available order options on the menu for each item. In one or more embodiments, the seller repository may include any repository accessible to the personalized, point-of-sale program 150, such as storage 124 or remote database 130.

In one or more embodiments, prior to beginning data collection, the personalized, point-of-sale program 150 may perform an opt-in procedure for each user wishing to use the personalized, point-of-sale program 150. The opt-in procedure may present a prompt to the user indicating that the personalized, point-of-sale program 150 may gather data, the types of data the personalized, point-of-sale program 150 may gather, and the uses for which the personalized, point-of-sale program 150 may use the gathered data. For example, the personalized, point-of-sale program 150 may present a prompt to the user indicating that the personalized, point-of-sale program 150 may gather information about consumer habits in order to make a prediction as to an item presented to a point-of-sale system for manual entry.

In one or more other embodiments, the personalized, point-of-sale program 150 may allow a user to manually configure certain user restrictions, such as brand preferences, item preferences, food allergies, or dietary restrictions. For example, upon initial configuration, the personalized, point-of-sale program 150 may prompt the user with a graphical user interface requesting any food allergies and/or dietary restrictions applicable to the user, such as, but not limited to, nut allergies, gluten intolerance, vegetarianism, veganism, lactose intolerance, etc. The personalized, point-of-sale program 150 may include a list of choices from which the user may interact with a display screen, such as a touchscreen, to make one or more selections.

In one or more further embodiments, the personalized, point-of-sale program 150 may gather user-specific information from multiple sellers in order to build a more robust knowledge corpus. For example, if a user frequents two separate sellers when purchasing various items, the personalized, point-of-sale program 150 may, when the information is accessible, gather user-specific information from each seller, perhaps through an application programming interface (API) thus allowing the personalized, point-of-sale program 150 to have a more complete picture of the user's purchase habits.

Next, at 204, the personalized, point-of-sale program 150 generates a knowledge corpus based on the captured user-specific data. As previously described, the knowledge corpus may be a store of user-specific information relating to user purchase habits. From the captured user-specific information, the personalized, point-of-sale program 150 may categorize user purchases by type such as, but not limited to, groceries, restaurant, and entertainment. Additionally, the personalized, point-of-sale program 150 may parse purchase details to determine purchase and preference aspects. For example, the personalized, point-of-sale program 150 may note that a user prefers hamburgers and, when a hamburger is ordered, the user requests no ketchup. Furthermore, the personalized, point-of-sale program 150 may gather the scope of options available in a given environment to thoroughly understand the relative preference of an ordered/purchased item against all available options. For example, the personalized, point-of-sale program 150 may understand the options for hamburger toppings at a given restaurant are ketchup, mayonnaise, cheese, mustard, lettuce, tomato, bacon, and barbeque sauce but, when ordering a hamburger, the user typically only orders a hamburger with mustard. Since relative preference may be temporally variable, the personalized, point-of-sale program 150 may allow the knowledge corpus to be modified and/or expanded to include additional indicators including, but not limited to, time of day, weather, and recent activity, to reflect these preferences. For example, a specific seller may have different purchase options available during the fall months than in the spring months due to item availability from wholesalers and purchaser preferences during those times of the year.

Then, at 206, the personalized, point-of-sale program 150 trains the knowledge corpus. The personalized, point-of-sale program 150 may continually train the knowledge corpus, such as through a neural network, in order to improve predictability and understanding of user preferences. For example, the personalized, point-of-sale program 150 may continually monitor, or after the expiration of preconfigured periods of time, the personalized, point-of-sale program 150 may recapture the user-specific information and reconfigure, or train, the knowledge corpus. The personalized, point-of-sale program 150 may perform the training through a feedback loop of recapturing historical, user-specific data and, in one or more embodiments, purge data older than a preconfigured age.

Next, at 208, the personalized, point-of-sale program 150 determines whether the knowledge corpus has reached a threshold confidence level. The personalized, point-of-sale program 150 may continually train the knowledge corpus until a threshold confidence level in various environments has been reached in order to provide suggestions given the available options. In each environment, any limitations (e.g., allergy, physical, etc.) may provide the initial restriction of the menu options and the personalized, point-of-sale program 150 may continually train on newly captured user-specific information until enough data is obtained for the personalized, point-of-sale program 150 to make a prediction above a threshold confidence level.

If the personalized, point-of-sale program 150 determines the knowledge corpus has reached a threshold confidence level (step 208, “Yes” branch), then the personalized, point-of-sale training process 200 may proceed to step 210 to deploy the knowledge corpus to a point-of-sale device. If the privacy-enhanced, biometrics-based authentication program 150 determines the knowledge corpus has not reached a threshold confidence level (step 208, “No” branch), then the personalized, point-of-sale training process 200 may return to step 202 to capture historical, user-specific data.

Then, at 210, the personalized, point-of-sale program 150 deploys the knowledge corpus to a point-of-sale device. The personalized, point-of-sale program 150 may allow for deployment to any number of point-of-sale devices. For example, the personalized, point-of-sale program 150 may be deployed to a point-of-sale self-checkout system in a grocery store or an ordering kiosk at a restaurant. Deployment of the knowledge corpus may include installation of the personalized, point-of-sale program 150 to each point-of-sale device. In one or more embodiments, deploying the knowledge corpus may include downloading the knowledge corpus to a storage unit of each point-of-sale device or connecting each point-of-sale device to the knowledge corpus through a network, such as WAN 102.

Referring now to FIG. 3, an operational flowchart for a personalized, point-of-sale operation process 300 is depicted, according to at least one embodiment. At 302, the personalized, point-of-sale program 150 detects an item placed on a point-of-sale device. The personalized, point-of-sale program 150 may detect the presence of an item placed on the point-of-sale device by a user through one or more detection methods including, but not limited to, detecting a weight variance through a scale on the point-of-sale device and image recognition of an area surrounding the point-of-sale device.

In one or more embodiments, rather than detecting the presence of an item presented by the user at the point-of-sale system, the personalized, point-of-sale program 150 may detect a user intention to manually interact with the point-of-sale system. For example, if the point-of-sale system is an ordering kiosk at a restaurant, the personalized, point-of-sale program 150 may identify the user's eye gaze at the display screen of the point-of-sale system as a detection of the user's desire to interact with the point-of-sale system.

Then, at 304, the personalized, point-of-sale program 150 generates a custom user interface display on the point-of-sale device. Once the personalized, point-of-sale program 150 detects the presence of an item, the personalized, point-of-sale program 150 may generate a custom user interface display that displays one or more items based on the knowledge base. For example, once the personalized, point-of-sale program 150 determines an item has been placed on a scale of the point-of-sale system, the personalized, point-of-sale program 150 may determine from the knowledge base that the user typically purchases bananas, apples, and oranges on a weekly basis and, due to the frequency of purchase, the personalized, point-of-sale program 150 may generate a graphical user interface that places bananas, apples, and oranges as the top choices for the user to select.

In one or more embodiments, the personalized, point-of-sale program 150 may generate a graphical user interface with several different user-specific categories based on the knowledge base. For example, the personalized, point-of-sale program 150 may include a category of most purchased items by the user, a category of predicted items based on user purchase frequency, a category of predicted items based on weight, and a category of predicted items based on appearance.

The category of most purchased items by the user may be based on identification of items most often purchased by the user at the specific seller according to information within the knowledge base. For example, if the user typically purchases apples from one specific seller and oranges from another seller, the personalized, point-of-sale program 150 may generate a category subheading or section on the graphical user interface that includes only apples and omits oranges since the personalized, point-of-sale program 150 may determine the user is presently at the specific seller and the personalized, point-of-sale program 150 has determined, based on the knowledge base, that the user typically only purchases apples at this seller.

The category of predicted items based on user purchase frequency may be a category of predictions by the personalized, point-of-sale program 150 based on the purchase frequency data within and derived from the knowledge base. For example, the personalized, point-of-sale program 150 may determine that a user purchases lettuce once a week and typically on a Sunday, which may indicate the user consumes lettuce with lunches on weekdays. Therefore, if the user is utilizing the point-of-sale device on a Sunday, the personalized, point-of-sale program 150 may predict that a category for predicted items based on user purchase frequency displayed on a point-of-sale display screen should include lettuce when the user presents an item for manual entry.

The category of predicted items based on weight may be a prediction by the personalized, point-of-sale program 150 of items typically purchased by the user based on specific weight of the item presented on a scale of the point-of-sale device. For example, if the user typically purchases four pounds of apples at a time, the personalized, point-of-sale program 150 may include apples in a category of predicted items based on weight on a display screen of the point-of-sale device when the scale registers the weight of an item for manual entry at 4.15 pounds.

The category of predicted items based on appearance may be a predictions of items presented by the user for purchase at a point-of-sale device based on characteristics of the item as detected by an image capture device. For example, the personalized, point-of-sale program 150 may determine that a user frequently purchases bananas but never purchases lemons based on the knowledge base. Therefore, if an image capture device associated with the point-of-sale device identifies the item presented for manual entry at the point-of-sale device is yellow in color, the personalized, point-of-sale program 150 may present bananas as an option for user selection from a category of predicted items based on appearance on the graphical user interface but omit lemons from the same category. In one or more other embodiments, the personalized, point-of-sale program 150 may utilize various other item characteristics identifiable by an image capture device include, but not limited to, smoothness, hardness, item count, and item shine.

In another embodiment, the personalized, point-of-sale program 150 may generate the graphical user interface based on user preferences within the knowledge corpus. As previously described, the personalized, point-of-sale program 150 may allow a user to manually enter brand preferences, item preferences, dietary restrictions, and food allergies. For example, the personalized, point-of-sale program 150 may provide a point-of-sale device at a grocery store checkout with preferred or recent purchases of a user and, on a top row of a graphical user interface, display specific varieties of produce (e.g., gala apple or yellow onion) when an item for manual entry is placed on a scale of the point-of-sale device. Furthermore, the personalized, point-of-sale program 150 may also automatically detect such preferences based on historical user purchase information within the knowledge corpus. For example, the personalized, point-of-sale program 150 may determine that a user frequently purchases items marked as gluten-free and located in a specialty section of a grocery store. Therefore, the personalized, point-of-sale program 150 may determine the user prefers items marked as gluten-free.

It may be appreciated that FIGS. 2 and 3 provide only an illustration of one implementation and do not imply any limitations with regard to how different embodiments may be implemented. Many modifications to the depicted environments may be made based on design and implementation requirements. For example, in a restaurant setting where a user interacts with an ordering kiosk, the personalized, point-of-sale program 150 may allow a suggested order to be defined or user-specific defaults to be added as the user goes through screen prompts to complete the ordering process. For instance, if a user orders a quarter pound hamburger with cheese, the personalized, point-of-sale program 150 may, through the knowledge base, determine the user never orders ketchup despite ketchup being a default condiment for the restaurant. As such, the personalized, point-of-sale program 150 may automatically deselect ketchup or mark a “no ketchup” option on the graphical user interface without requiring the user's manual selection of such an option.

In one or more additional embodiments, the personalized, point-of-sale program 150 may track other users frequenting establishments with the user and user preferences associated with the other users. Therefore, the personalized, point-of-sale program 150 may determine specific users with whom a user typically frequents an establishment. For example, if a user frequently visits a restaurant with another individual, the personalized, point-of-sale program 150 may identify this attendance and, when a user visits that establishment, assume the other user is in attendance and, when an item associated with the other user is ordered on an ordering kiosk, customize the order according to the other user's preferences as stored in the knowledge base.

In one or more embodiments, the personalized, point-of-sale program 150 may present a notification to the user through the point-of-sale system display screen that an item ordered or presented for purchase may be or includes an ingredient subject to an allergy or food restriction for the user. For example, if the personalized, point-of-sale program 150 understands the user has a nut allergy and the user has presented an item with nuts as an ingredient, the personalized, point-of-sale program 150 may present a notification to the user that the item contains an ingredient of which the user is allergic.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
detecting an object for purchase that requires additional user input on a point-of-sale (POS) device; and
generating a custom user interface display on the POS device based, at least in part, on the detected object and historical purchase information associated with a user purchasing the detected object.

2. The method of claim 1, wherein generating the custom user interface display further comprises:
determining a category associated with the detected object; and
auto-populating a sub-set of a possible set of objects associated with the category based on the user's historical purchase information associated with objects included in the determined category.

3. The method of claim 2, wherein the sub-set of the possible set of objects associated with the determined category are listed in hierarchical order based on a determined likelihood of the user to purchase a particular object associated with the determined category.

4. The method of claim 2, further comprising:
receiving a user selection of an object from the sub-set of the possible set of objects auto-populated via the custom user interface display; and
auto-selecting one or more user options associated with the selected object based, at least in part, on the historical purchase information associated with the selected object.

5. The method of claim 2, further comprising:
auto-populating additional objects included in the possible set of objects associated with the category via the custom user interface display in response to receiving a user request for additional objects;
receiving a user selection of an object from the additional objects auto-populated via the custom user interface display;
determining that the selected object includes one or more ingredients that the user does not prefer or is allergic to; and
alerting the user that the selected object includes the one or more ingredients that the user does not prefer or is allergic to.

6. The method of claim 1, further comprising:
capturing historical, user-specific data;
generating a knowledge corpus based on the captured data; and
training the knowledge corpus.

7. The method of claim 6, wherein the training is performed through a neural network performing a feedback loop of recapturing historical, user specific data, and wherein any historical, user-specific data older than a preconfigured age is purged from the generated knowledge corpus.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
detecting an object for purchase that requires additional user input on a point-of-sale (POS) device; and
generating a custom user interface display on the POS device based, at least in part, on the detected object and historical purchase information associated with a user purchasing the detected object.

9. The computer system of claim 8, wherein generating the custom user interface display further comprises:
determining a category associated with the detected object; and
auto-populating a sub-set of a possible set of objects associated with the category based on the user's historical purchase information associated with objects included in the determined category.

10. The computer system of claim 9, wherein the sub-set of the possible set of objects associated with the determined category are listed in hierarchical order based on a determined likelihood of the user to purchase a particular object associated with the determined category.

11. The computer system of claim 9, wherein the method further comprises:
receiving a user selection of an object from the sub-set of the possible set of objects auto-populated via the custom user interface display; and
auto-selecting one or more user options associated with the selected object based, at least in part, on the historical purchase information associated with the selected object.

12. The computer system of claim 9, wherein the method further comprises:
auto-populating additional objects included in the possible set of objects associated with the category via the custom user interface display in response to receiving a user request for additional objects;
receiving a user selection of an object from the additional objects auto-populated via the custom user interface display;
determining that the selected object includes one or more ingredients that the user does not prefer or is allergic to; and
alerting the user that the selected object includes the one or more ingredients that the user does not prefer or is allergic to.

13. The computer system of claim 8, wherein the method further comprises:
capturing historical, user-specific data;
generating a knowledge corpus based on the captured data; and
training the knowledge corpus.

14. The computer system of claim 13, wherein the training is performed through a neural network performing a feedback loop of recapturing historical, user specific data, and wherein any historical, user-specific data older than a preconfigured age is purged from the generated knowledge corpus.

15. A computer program product, the computer program product comprising:
one or more computer-readable tangible storage medium and program instructions stored on at least one of the one or more tangible storage medium, the program instructions executable by a processor capable of performing a method, the method comprising:
detecting an object for purchase that requires additional user input on a point-of-sale (POS) device; and
generating a custom user interface display on the POS device based, at least in part, on the detected object and historical purchase information associated with a user purchasing the detected object.

16. The computer program product of claim 15, wherein generating the custom user interface display further comprises:
determining a category associated with the detected object; and
auto-populating a sub-set of a possible set of objects associated with the category based on the user's historical purchase information associated with objects included in the determined category.

17. The computer program product of claim 16, wherein the sub-set of the possible set of objects associated with the determined category are listed in hierarchical order based on a determined likelihood of the user to purchase a particular object associated with the determined category.

18. The computer program product of claim 16, wherein the method further comprises:
receiving a user selection of an object from the sub-set of the possible set of objects auto-populated via the custom user interface display; and
auto-selecting one or more user options associated with the selected object based, at least in part, on the historical purchase information associated with the selected object.

19. The computer program product of claim 16, wherein the method further comprises:
auto-populating additional objects included in the possible set of objects associated with the category via the custom user interface display in response to receiving a user request for additional objects;
receiving a user selection of an object from the additional objects auto-populated via the custom user interface display;
determining that the selected object includes one or more ingredients that the user does not prefer or is allergic to; and
alerting the user that the selected object includes the one or more ingredients that the user does not prefer or is allergic to.

20. The computer program product of claim 15, wherein the method further comprises:
capturing historical, user-specific data;
generating a knowledge corpus based on the captured data; and
training the knowledge corpus.
